(19) United States
(12) Patent Application Publication
(10) Pub. No.: US 2025/0378596 A1
(43) Pub. Date: Dec. 11, 2025

(54) GENERATING SYNTHETIC IMAGES FOR TRAINING MACHINE LEARNING MODELS

(71) Applicant: Robert Bosch GmbH, Stuttgart (DE)

(72) Inventors: Kevin Alexander LAUBE, Renningen (DE); Julio BORGES, Stuttgart (DE); Shin-I CHENG, Stuttgart (DE)

(21) Appl. No.: 19/206,766

(22) Filed: May 13, 2025

(30) Foreign Application Priority Data
May 15, 2024 (EP) 24 17 6086.7

(51) Int. Cl. G06T 11/00; G06N 20/00; G06V 10/774

(52) U.S. Cl. CPC G06T 11/00; G06N 20/00; G06V 10/774

(57) ABSTRACT

A method for training a diffusion model, which can be used to iteratively generate a synthetic image from noise in conjunction with a specified conditioning. In the method: a style that the synthetically generated images should have is specified; a set of training images that match the specified style to varying degrees is provided; noise is successively applied to the training images in a specified number of iterations, so that noised versions are created in each case; samples are drawn from the noised versions; the drawn samples are processed by the diffusion model in conjunction with the specified conditioning to produce predictions for the previous noised version in each case; the correspondence between these predictions and the actual noised versions in each case is evaluated by using a specified cost function; and parameters that characterize the behavior of the diffusion model are optimized.

### FIELD

The present invention relates to the generation of synthetic images that can be used as training examples for machine learning models and, in particular, can help alleviate a shortage of training examples that are “labeled” with prior knowledge.

### BACKGROUND INFORMATION

Machine learning models are increasingly being used to evaluate images, particularly within the framework of environmental monitoring of vehicles or robots during at least partially automated driving on company premises or in public transport. These models have the advantageous property that, after training, they generalize to images unseen during training based on a limited set of training examples. This simulates, in the broadest sense, the learning process of a human driver who, after only a few tens of driving hours and less than 1,000 km of driving experience, has experienced a very limited selection of situations occurring in traffic. Generally, even after this very limited training, the driver still manages to master situations that were not seen during training.

The training of machine learning models is often carried out in a monitored manner. This means that the training examples are “labeled” with prior knowledge in the form of a target output that the machine learning model is to ideally generate from the training example. The training progress is then measured by the extent to which the machine learning model, on average, delivers outputs for all training examples that are consistent with the target outputs.

“Labeling” training examples is a substantially manual process and is therefore a major driver of the time and cost involved in training.

### SUMMARY

The present invention provides a method for training a diffusion model. As such, a diffusion model transforms a statistical distribution, such as normally distributed noise, into another distribution, such as the distribution of realistic-looking images. In conjunction with a specified conditioning, such as text or semantic segmentation, a diffusion model can be used to iteratively generate a synthetic image that is consistent with this conditioning. For example, a textual input can be specified as conditioning in order to generate a synthetic image with a specified content. In this respect, the diffusion model can be designed to iteratively generate a synthetic image from noise in conjunction with a specified conditioning, which image is consistent with this conditioning.

According to an example embodiment of the present invention, within the framework of the method, a style that the synthetically generated images should have is specified. A set of training images x₀ that match the specified style to varying degrees is provided.

Noise is successively applied to the training images x₀ in a specified number T of iterations, so that noised versions x₁, . . . . x_{T} are created in each case. Samples xₜ are drawn from the noised versions x₁, . . . , x_{T}. The samples xₜ drawn are processed by the diffusion model in conjunction with the specified conditioning to produce predictions \hat{x}ₜ₋₁ for the previous noised version xₜ₋₁ in each case.

The correspondence between these predictions \hat{x}ₜ₋₁ and the actual noised versions xₜ₋₁ in each case is evaluated by using a specified cost function. Parameters that characterize the behavior of the diffusion model are optimized with the aim of improving the evaluation that uses the cost function during further processing of training images x₀ and samples xₜ generated from them.

When drawing the samples xₜ and/or when evaluating the predictions generated from them \hat{x}ₜ₋₁ by using the cost function, those samples xₜ that still reflect the style of the particular training image x₀ are represented more strongly, the more closely the particular training image x₀ matches the specified style.

It was recognized that in this manner
the diffusion model can be trained to generate synthetically generated images that match the specified style,
without it being necessary to limit the training examples to this specified style from the outset.

Generating synthetic images with a certain specified style improves the suitability of these synthetically generated images as training examples for training a machine learning model. For such training, synthetically generated images are not usually used exclusively; rather, an already existing limited set of physically recorded training examples is often supplemented with synthetically generated training examples. For optimal training, the synthetically generated training examples should belong to the same domain and/or distribution as the physically recorded training examples. The physically recorded training examples, in turn, are often characterized by certain peculiarities of the image recording.

If images are recorded, for example, by using a camera mounted on a vehicle, the images may not be as perfect as those recorded with a professional motion picture camera, due to the limited size of the vehicle-mounted camera. Synthetically generated images can, for example, be “too perfect” in the sense that they are of much better quality than would be possible with the camera mounted on the vehicle. Thus, such synthetically generated images do not belong to the domain and/or distribution of the physically recorded images; rather, they create a domain shift. However, the method according to the present invention disclosed herein can generate images that are significantly more similar to the existing physically recorded images.

The same applies if synthetic images have already been generated from another source and this existing set is to be meaningfully supplemented. Methods for synthetic image generation can also impart their own style to the images, for example in the form of characteristic artifacts.

In principle, the limitation to generating images of a certain style could be enforced by restricting the training examples from the outset to those that match the specified style. This would sacrifice a large part of the total available training examples. However, it has been recognized that during the successive noising of the training image, the information related to the style of the image becomes unrecognizable faster than information related to the content. Thus, even if the noise continues to increase, it is still possible to see what is supposed to be shown in the image for a relatively long time. However, it is for example relatively quickly no longer possible to tell which camera was used to record the image.

Thus, for example, iterations xₜ can be sampled for training images x₀ that do not match the specified style, the noising of which iterations is already so advanced that the style can no longer be unambiguously reconstructed from them. This makes it possible to train the essential capabilities of the diffusion model to reconstruct content with greater variability. However, iterations xₜ from which the style can be unambiguously reconstructed can then be sampled only for those training images x₀ that match the specified style. Thus, whenever the diffusion model reconstructs an element of style, it does so only for training images x₀ of the corresponding style.

Alternatively, or in combination with this, the influence of samples xₜ that still unambiguously reflect the “incorrect” style on the training result of the diffusion model can also be reduced via the cost function. Whether a modification of the cost function or a modification of the sampling is easier to implement depends on the specific application.

In a particularly advantageous example embodiment of the present invention, the set of training images x₀ is divided into a correct subset consisting of those training images x₀, that match the specified style, and a false subset consisting of those training images x₀ that do not match the specified style. When drawing the samples xₜ and/or evaluating the predictions \hat{x}ₜ₋₁ generated from them by using the cost function, samples xₜ that still reflect the style of the particular training image x₀ are only taken into account to the extent that they originate from training images x₀ from the correct subset. As previously explained, in this manner the information content of the training images x₀ in the false subset can be optimally utilized.

For this purpose, for example, a threshold value S can be defined, up to which samples xₜ with t≤S still reflect the style of the particular training image x₀. A threshold value S can quickly be identified above which all style information from the samples xₜ with t>S has definitely disappeared. Within the framework of the method, it is also not a problem if the threshold value S is set too high. This merely excludes some contributions from training images x₀ in the false subset, but does not change the fact that the style of the generated image still matches the desired specified style.

If the training images x₀ are noised, for example in T=1000 iterations, a threshold value of S=200 iterations can be defined, below which the samples xₜ with t≤S still reflect the style of the particular training image x₀.

In order to optimize the threshold value S, in another particularly advantageous example embodiment of the present invention, for a plurality of candidate threshold values S*, it is tested whether the style of the particular training image x₀ can still be unambiguously ascertained from samples x_{S*}. For this test, for example, a classifier can be used that is designed to assign classification scores to the sample x_{S*} in relation to one or more styles. If, for example, similar classification scores are then assigned to a plurality of different styles, the decision in favor of a particular style is no longer unambiguous.

In particular, the specified style can characterize, for example, a transfer function that translates the semantic content of an image into the image. It can thus refer to the process by which the particular image was generated and, in particular, can contain traces that this process leaves behind in the training images x₀. The method can thus be used particularly effectively to generate synthetic images that appear as if they were obtained using the same process as the training images x₀.

This applies even more so in a further particularly advantageous embodiment of the present invention in which the specified style characterizes a device with which an image was recorded and/or an algorithm with which an image x₀ was synthetically generated. For example, the style can characterize a camera used to record images or can roughly outline a method for synthetically generating images.

This definition of style differs from the common usage in the field of machine learning, which substantially distinguishes between semantic content, on the one hand, and style, on the other hand. According to this usage, colors or materials of objects, lighting conditions, times of day and seasons are also considered part of style. Strictly speaking, however, these are elements of a “semantic style” that depends more on the properties of certain objects than on the imaging process as a whole. In the context of the method proposed here, the primary objective is to preserve the generation style of the training images x₀, regardless of whether this generation was carried out by a physical imaging system (such as a camera) or by an algorithm.

Thus, the specified style can in particular comprise, for example,
an image distortion, and/or
focus blur, and/or
a color scheme and/or a color cast, and/or
one or more textures, and/or
one or more artifacts that occurred during the generation of the training image x₀.

In a large set of training images x₀ containing a mix of many styles, only a comparatively small number of training images x₀ will match the specified style. Therefore, in relation to most training images x₀, it is to be expected that the sampled noised versions xₜ will be restricted to those iteration indices t where the style has certainly been rendered unrecognizable by the noising. This can lead to an underrepresentation of the lower iteration indices t, which belong to the less-noised versions, in the total set of samples xₜ drawn from all training images x₀. In order to counteract this tendency, in a further particularly advantageous embodiment of the present invention,
a frequency at which such samples xₜ are drawn that still reflect the style of the particular training image x₀, and/or
a frequency at which such samples xₜ are drawn that originate from training images x₀ with the specified style,
   is adjusted so that the iteration indices t of the total samples drawn are distributed according to a specified distribution. This specified distribution can be, in particular, an equal distribution or a normal distribution.

In a further particularly advantageous example embodiment of the present invention, the specified conditioning comprises
a composition of the training image x₀ which consists of objects, and/or
edges of the training image x₀, and/or
other information about the layout of the training image x₀.

In this way, specific variations of the training image x₀ can be generated that have the same spatial layout and/or semantic content, but that display these contents differently. At the same time, the synthetically generated images still belong to the domain and/or distribution of those images that were generated in the same way as the original training image x₀. This makes the synthetically generated images particularly suitable as training examples for a machine learning model. In particular, labels of the training images x₀ in the form of target outputs that the machine learning model are to generate from the training images x₀ can be reused during the monitored training of such a model.

If the diffusion model is fully trained, samples of noise are drawn from a noise distribution in a further particularly advantageous embodiment and supplied to the trained diffusion model in conjunction with the specified conditioning. This creates synthetically generated images. According to the method proposed here, the synthetically generated images match the specified style.

As explained above, these synthetically generated images are particularly suitable as training examples for machine learning models. Therefore, a machine learning model is trained in a further particularly advantageous embodiment by using the synthetically generated images as training examples. In particular, the synthetically generated image integrates better into a domain and/or distribution of already existing training examples. In this way, the synthetically generated training example is a real help for the training in progress and not a disruptive factor that pulls this training with a domain shift in a different direction than planned. The machine learning model is usually trained for a certain task and is therefore also referred to as a task model.

In a further particularly advantageous example embodiment of the present invention, input images that have been recorded with at least one sensor will be supplied to the machine learning model trained in this manner. From the output subsequently delivered by the machine learning model, a control signal is formed. A vehicle, a driver assistance system, a robot, a system for quality control, a system for monitoring regions, and/or a system for medical imaging is controlled with the control signal. Due to the improved training, the probability is then increased that the reaction of the controlled system in each case to the control signal of the situation embodied in the input images is appropriate.

The method of the present invention can in particular be wholly or partially computer-implemented. The present invention therefore also relates to a computer program comprising machine-readable instructions that, when executed on one or more computers and/or compute instances, cause the computer(s) and/or compute instance(s) to execute the described method. In this sense, control devices for vehicles and embedded systems for technical devices, which are also capable of executing machine-readable instructions, are also to be regarded as computers. Compute instances can, for example, be virtual machines, containers, or serverless execution environments, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for training a diffusion model 1, according to the present invention.

FIG. 2 shows examples of the effect of increasing noise on the recognizability of the style of images, according to the present invention.

FIG. 3 is a schematic illustration of the favoring of less-noised iterations xₜ only for training images x₀ that match the specified style 5, according to an example embodiment of the present invention

### DETAILED DESCRIPTION OF EXAMPLE EMBODIMENTS

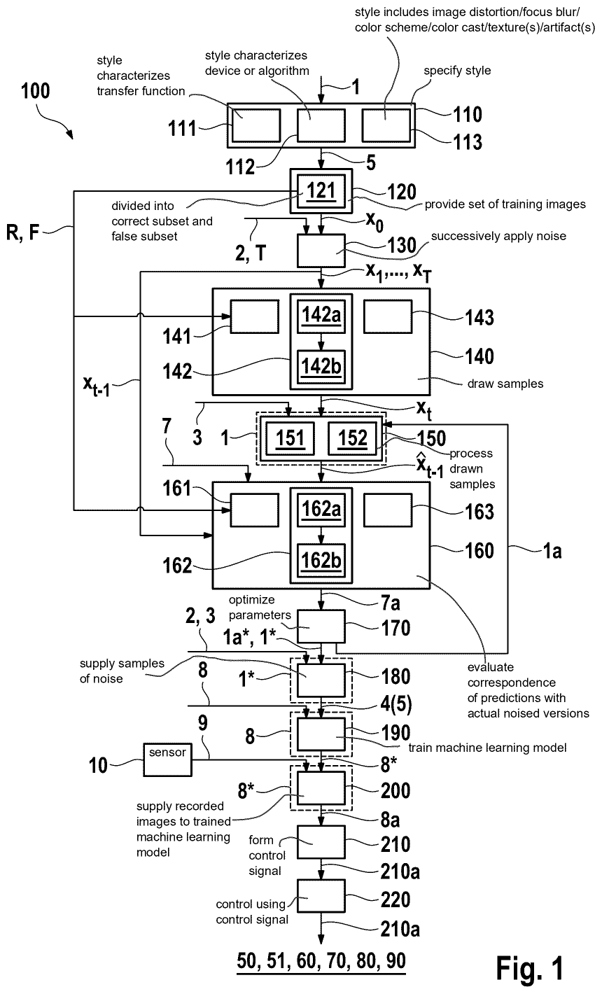

FIG. 1 is a schematic flow chart of an exemplary embodiment of the method 100 for training a diffusion model 1. The diffusion model 1 can be used to generate a synthetic image 4 from noise 2 in conjunction with a specified conditioning 3 in an iterative manner.

In step 110, a style 5 is specified, which the images 4 synthetically generated by the fully trained diffusion model 1 are intended to have.

According to block 111, the specified style 5 can characterize a transfer function that translates the semantic content of an image into the image.

According to block 112, the specified style 5 can characterize a device with which an image was recorded and/or an algorithm with which an image was synthetically generated.

According to block 113, the specified style 5 can comprise
an image distortion, and/or
focus blur, and/or
a color scheme and/or a color cast, and/or
one or more textures, and/or
one or more artifacts that occurred during the generation of the training image x₀.

In step 120, a set of training images x₀ that match the specified style 5 to varying degrees is provided.

According to block 121, the set of training images x₀ can be divided into a correct subset R of those training images x₀ that match the specified style 5 and a false subset F of those training images x₀ that do not match the specified style 5.

In step 130, noise 2 is successively applied to the training images x₀ in a specified number T of iterations, so that noised versions x₁, . . . , x_{T} are created in each case.

In step 140, samples xₜ are drawn from the noised versions x₁, . . . , x_{T}.

In step 150, the samples xₜ drawn are processed by the diffusion model 1 in conjunction with the specified conditioning 3 to produce predictions \hat{x}ₜ₋₁ for the previous noised version xₜ₋₁ in each case.

According to block 151, the specified conditioning 3 can comprise
a composition of the training image x₀ which consists of objects, and/or
edges of the training image x₀, and/or
other information about the layout of the training image x₀.

According to block 152, the specified conditioning 3 can comprise a property of the training image x₀, which property is to be ascertained by a machine learning model 8 to be trained and for which property prior knowledge is available for the monitored training of the machine learning model 8. In this way, augmented versions of that same training image x₀ can be generated, for which the labels of the training image x₀ can be reused.

In step 160, the correspondence of these predictions xₜ₋₁ with the actual noised versions xₜ₋₁ in each case is evaluated by using a specified cost function 7. An evaluation 7a is created.

In step 170, parameters 1a that characterize the behavior of the diffusion model 1 are optimized with the aim of improving the evaluation 7a that uses the cost function during further processing of training images x₀ and samples xₜ generated therefrom. The fully optimized state of the parameter 1a is indicated by the reference sign 1a* and defines the fully trained state 1* of the diffusion model 1.

When drawing 140 the samples xₜ and/or evaluating 160 the predictions îₜ₋₁ generated from them by using the cost function 7, those samples xₜ that still reflect the style of the particular training image x₀ are represented more strongly, the more the particular training image x₀ matches the specified style 5.

This may mean in particular, for example according to block 141 or 161, that when drawing 140 the samples xₜ and/or evaluating 160 the predictions \hat{x}ₜ₋₁ generated from them by using the cost function 7, samples xₜ that still reflect the style of the particular training image x₀ are only taken into account to the extent that they originate from training images x₀ from the correct subset R formed according to block 121.

According to block 142 or 162, a threshold value S can be defined, up to which samples xₜ with t≤S still reflect the style of the particular training image x₀. In order to define this threshold value, it is possible in particular, for example,
according to block 142a or 162a, to test, for a plurality of candidate threshold values S*, to determine whether the style of the particular training image x₀ can still be unambiguously ascertained from the samples x_{S*}, and
according to block 142b or 162b, to select as the threshold value S* a candidate threshold value S for which this no longer proves possible.

According to block 143 or 163,
a frequency at which such samples xₜ are drawn that still reflect the style of the particular training image x₀, and/or
a frequency at which such samples xₜ are drawn that originate from training images x₀ with the specified style,
   can be adjusted such that the iteration indices t of the total samples drawn are distributed according to a specified distribution.

In the example shown in FIG. 1, samples of noise 2 from a noise distribution together with a specified conditioning 3 are supplied to the trained diffusion model 1 in step 180. Synthetically generated images are then created 4.

In step 190, a machine learning model 8 designed for the solution of a specified task is trained by using the synthetically generated images 4 as training examples. The fully trained state of this machine learning model is indicated by the reference sign 8*.

In step 200, input images 9 recorded with at least one sensor 10 are supplied to the trained machine learning model 8*. This creates outputs 8a.

In step 210, a control signal 210a is formed from these outputs 8a. In step 220, a vehicle 50, a driver assistance system 51, a robot 60, a system 70 for quality control, a system 80 for monitoring regions, and/or a system 90 for medical imaging, is controlled with the control signal 210a.

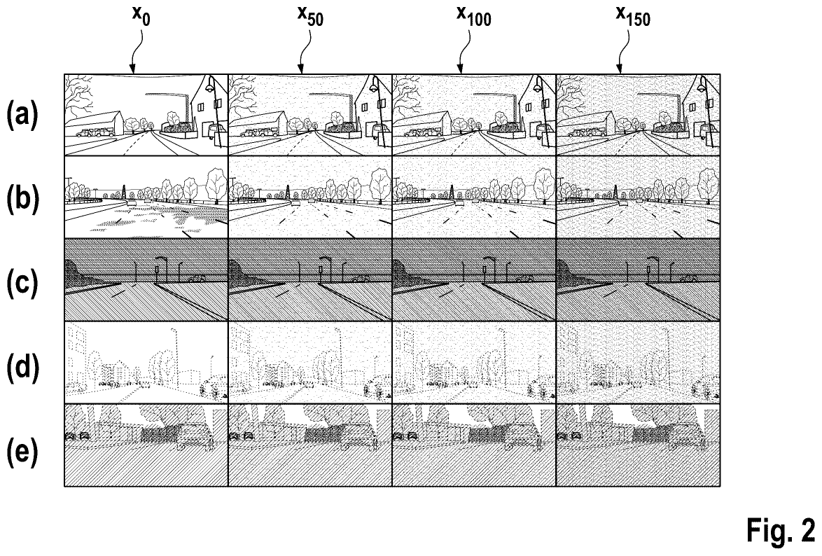

FIG. 2 shows five examples (a) to (e) of training images x₀. These training images x₀ obviously differ not only in their particular content, but also in their style of generation. For instance, in example (a), it is noticeable that the image is clearly distorted by a fisheye effect caused by the camera used. The traffic situation shown in example (b), which takes place on a highway, appears at first glance “too good” for a photograph, and the texture of the road surface exhibits artifacts that are typical of synthetic image generation. In example (c), regions of the image where the light intensity is below a certain value are all black. Example (d) shows blurred color contrast. Example (e) shows focus blurring, and regions of the image where the light intensity is above a certain value are all white.

For each of these training images x₀ FIG. 2 shows noised versions x₅₀, x₁₀₀ and x₁₅₀ in each case, which are created after 50, 100 or 150, respectively, successive iterations of the noising. The substantial semantic contents of the training images x₀ remain recognizable even after 150 iterations of the noising. However, the differences in the style of generation are greatly leveled out. For example, the fisheye effect of example (a) is hardly noticeable, the texture artifact in example (b) is no longer visible, and the focus blurring in example (e) is also obscured by the noise. Thus, heavily-noised iterations xₜ can be used from all training images x₀ without thereby “contaminating” the training of diffusion model 1 with an “incorrect” style. Less-noised iterations xₜ should only be used from training images x₀ whose style matches the specified style 5.

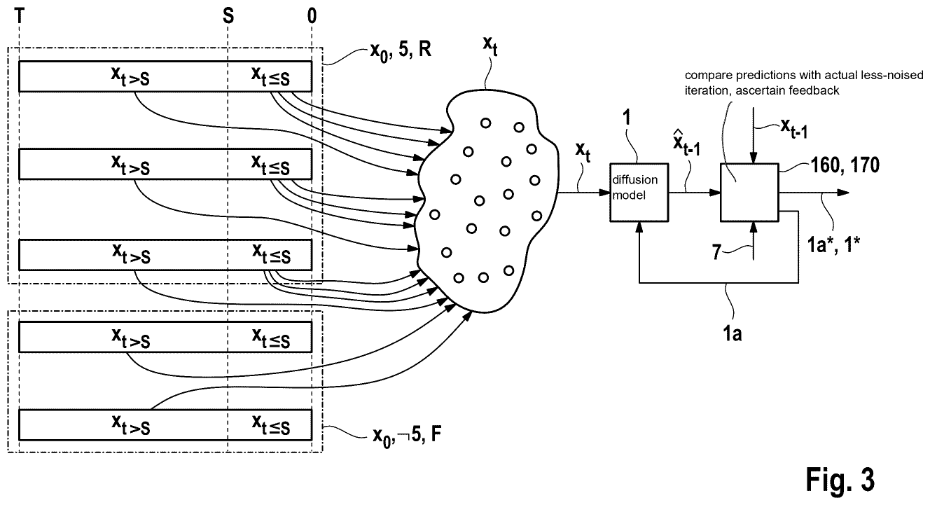

This is schematically illustrated in more detail in FIG. 3. In the example shown in FIG. 3, there are three training images x₀ that match the specified style 5 and thus belong to the correct set R formed in block 121, and two training images x₀ that do not match the specified style 5 (¬5=“not 5”) and thus belong to the false set F formed in block 121. All training images x₀ were noised over T iterations. A threshold value S was defined such that the noised iterations x_{t>S} no longer contain any information about the style of generation of the original training image x₀, whereas the noised iterations x_{t≤S} still reflect this style of generation.

Of all training images x₀, in each case heavily-noised iterations x_{t>S} are taken into account. However, less-noised iterations x_{t≤S} are only taken into account if the particular training image x₀ belongs to the correct set R. All samples xₜ drawn are combined in a pool and supplied to the diffusion model 1 to be trained. For training images x₀ from the correct set R in each case, a greater number of less-noised samples x_{t≤S} than heavily-noised samples x_{t>S} are taken into account, so that the iteration indices t present in the overall pool are approximately uniformly distributed.

The diffusion model 1 generates, for each sample xₜ from the pool, a prediction \hat{x}ₜ₋₁ in each case for the previous, slightly less-noised iteration xₜ₋₁. In step 160 of method 100, this prediction \hat{x}ₜ₋₁ is compared with the actual, less-noised iteration xₜ₋₁. The result of this comparison is evaluated using the specified cost function 7, and in step 170 of the method 100, feedback is ascertained for the parameters 1a which characterize the behavior of the diffusion model 1. Fully optimized parameters 1a* are created, which define the fully trained state 1* of the diffusion model 1.

1-16. (canceled)

17. A method for training a diffusion model, which can be used to iteratively generate a synthetic image from noise in conjunction with a specified conditioning, the synthetic image being consistent with the conditioning, the method comprising the following steps:
specifying a style that the synthetically generated images should have;
providing a set of training images that match the specified style to varying degrees;
successively applying noise to each respective training image of the training images in a specified number of iterations, so that respective noised versions are created;
drawing samples from the respective noised versions;
processing each of the drawn samples by the diffusion model in conjunction with the specified conditioning to produce predictions for a previous noised version in each case;
evaluating a correspondence between the predictions and the noised versions using a specified cost function; and
optimizing parameters that characterize a behavior of the diffusion model with an aim of improving the evaluation that uses the cost function during further processing of training images and samples generated from the training images;
wherein, when drawing the samples, and/or when evaluating the predictions generated from the drawn samples using the cost function, those samples that still reflect the style of the respective training image are represented more strongly, the more closely the respective training image matches the specified style.

18. The method according to claim 17, wherein:
the set of training images is divided into a correct subset of the training images that match the specified style and a false subset of the training images that do not match the specified style; and
when drawing the samples, and/or when evaluating the predictions generated from samples drawn by using the cost function, those samples that still reflect the style of the respective training image are only taken into account to the extent that they originate from training images from the correct subset.

19. The method according to claim 17, wherein a threshold value S is defined, up to which samples xₜ with t≤S still reflect the style of the respective training image.

20. The method according to claim 19, wherein
for a plurality of candidate threshold values S*, it is tested whether the style of the respective training image x₀ can still be unambiguously ascertained from samples x_{S*}, and
a candidate threshold value S* for which it is no longer proves possible for the style of the respective training image x₀ to be unambiguously ascertained from samples x_{S*}, is selected as the threshold value S.

21. The method according to claim 17, wherein the specified style characterizes a transfer function that translates semantic content of an image into the image.

22. The method according to claim 17, wherein the specified style characterizes a device with which an image was recorded and/or an algorithm with which an image was synthetically generated.

23. The method according to claim 17, wherein the specified style includes:
an image distortion, and/or
focus blur, and/or
a color scheme and/or a color cast, and/or
one or more textures, and/or
one or more artifacts that occurred during generation of a training image.

24. The method according to claim 17, wherein
a frequency at which such samples are drawn that still reflect the style of the respective training image, and/or
a frequency at which such samples are drawn that originate from those of the training images with the specified style,
is adjusted so that iteration indices of the total samples drawn are distributed according to a specified distribution.

25. The method according to claim 17, wherein the specified conditioning includes:
a composition of the training image which consists of objects, and/or
edges of the training image, and/or
other information about the layout of the training image.

26. The method according to claim 17, wherein the specified conditioning includes a property of the training image, which is to be ascertained by a machine learning model to be trained and for which property prior knowledge is available for monitored training of the machine learning model.

27. The method according to claim 17, wherein samples of noise from a noise distribution together with a specified conditioning are supplied to the trained diffusion model, so that synthetically generated images are created.

28. The method according to claim 27, wherein a machine learning model is trained by using the synthetically generated images as training examples.

29. The method according to claim 28, wherein:
input images recorded with at least one sensor are supplied to the trained machine learning model;
from output subsequently delivered by the machine learning model, a control signal is formed; and
a vehicle, and/or a driver assistance system, and/or a robot, and/or a system for quality control, and/or a system for monitoring regions, and/or a system for medical imaging, is controlled with the control signal.

30. A non-transitory machine-readable data carrier on which is stred a computer program including machine-readable instructions for training a diffusion model, which can be used to iteratively generate a synthetic image from noise in conjunction with a specified conditioning, the synthetic image being consistent with the conditioning, the instructions, when executed by one or more computers and/or compute instances, cause the one or more computers and/or compute instances to perform the following steps:
specifying a style that the synthetically generated images should have;
providing a set of training images that match the specified style to varying degrees;
successively applying noise to each respective training image of the training images in a specified number of iterations, so that respective noised versions are created;
drawing samples from the respective noised versions;
processing each of the drawn samples by the diffusion model in conjunction with the specified conditioning to produce predictions for a previous noised version in each case;
evaluating a correspondence between the predictions and the noised versions using a specified cost function; and
optimizing parameters that characterize a behavior of the diffusion model with an aim of improving the evaluation that uses the cost function during further processing of training images and samples generated from the training images;
wherein, when drawing the samples, and/or when evaluating the predictions generated from the drawn samples using the cost function, those samples that still reflect the style of the respective training image are represented more strongly, the more closely the respective training image matches the specified style.

31. One or more computers and/or compute instances including a non-transitory machine-readable data carrier on which is stred a computer program including machine-readable instructions for training a diffusion model, which can be used to iteratively generate a synthetic image from noise in conjunction with a specified conditioning, the synthetic image being consistent with the conditioning, the instructions, when executed by the one or more computers and/or compute instances, cause the one or more computers and/or compute instances to perform the following steps:
specifying a style that the synthetically generated images should have;
providing a set of training images that match the specified style to varying degrees;
successively applying noise to each respective training image of the training images in a specified number of iterations, so that respective noised versions are created;
drawing samples from the respective noised versions;
processing each of the drawn samples by the diffusion model in conjunction with the specified conditioning to produce predictions for a previous noised version in each case;
evaluating a correspondence between the predictions and the noised versions using a specified cost function; and
optimizing parameters that characterize a behavior of the diffusion model with an aim of improving the evaluation that uses the cost function during further processing of training images and samples generated from the training images;
wherein, when drawing the samples, and/or when evaluating the predictions generated from the drawn samples using the cost function, those samples that still reflect the style of the respective training image are represented more strongly, the more closely the respective training image matches the specified style.
